(19) United States
(12) Patent Application Publication
(10) Pub. No.: US 2004/0191058 A1
(43) Pub. Date: Sep. 30, 2004

(54) COMPRESSOR BLEED

(76) Inventors: P. William Baumann, Georgetown, MA (US); Brian J. Neiberg, West Hartford, CT (US); Thomas L. Creason, Palm Beach Gardens, FL (US); Brian E. Clouse, Saugus, MA (US)

Correspondence Address: BACHMAN & LAPOINTE, P.C., 900 CHAPEL STREET, SUITE 1201, NEW HAVEN, CT, 06510, US

(21) Appl. No.: 10/404,847

(22) Filed: Mar. 31, 2003

(51) Int. Cl. F03D 7/00

(52) U.S. Cl. 415/144

(57) ABSTRACT

A turbine engine stator segment has an outer wall segment with inboard and outboard surfaces. An inner wall segment has inboard and outboard surfaces essentially sharing an axis with those of the outer wall segment. Airfoils forming a sector of a first airfoil stage extend between the wall segments. The outboard wall segment has a compressor bleed port mounted at least along a forward edge by a lip projecting rearward and radially outward. The lip has inner and outer surfaces and a rim and projects radially beyond an adjacent portion of the outer wall segment.

### U.S. GOVERNMENT RIGHTS

The invention was made with U.S. Government support under contract N-00019-02-C-3003 awarded by the U.S. Navy. The U.S. Government has certain rights in the invention.

### BACKGROUND OF THE INVENTION

(1) Field of the Invention

This invention relates to turbine engine compressors, and more particularly to compressor bleeds from high pressure compressors.

(2) Description of the Related Art

Multi-stage axial flow compressors are typically used in gas turbine engines to supply high pressure gas for combustion and subsequent expansion in a coaxial multi-stage turbine. In normal operation, the turbine, in turn, drives the compressor. Many engine configurations split the compressor and turbine into high and low pressure/speed sections whose blades are mounted on respective high and low speed spools. A typical engine core flowpath extends through the low compressor, high compressor, combustor, high turbine, and low turbine in sequence.

Compressor air is commonly bled from the core flowpath through bleed ports in the outer wall surrounding the flowpath. The bleed air may be used for several purposes. It may be directed for internal cooling of the turbine blades and vanes. It may be directed to provide thermal and/or mechanical energy for external systems (e.g., aircraft HVAC, de-icing, cross-bleed engine starting, and the like). During start-up, a relatively downstream bleed (e.g., in the later stages of the high compressor) may limit backpressure and, thereby, reduce stall tendencies.

### BRIEF SUMMARY OF THE INVENTION

Accordingly, one aspect of the invention involves a turbine engine stator segment has an outer wall segment with inboard and outboard surfaces. An inner wall segment has inboard and outboard surfaces essentially sharing an axis with those of the outer wall segment. Airfoils forming a sector of a first airfoil stage extend between the wall segments. The outboard wall segment has a compressor bleed port mounted at least along a forward edge by a lip projecting rearward and radially outward. The lip has inner and outer surfaces and a rim and projects radially beyond an adjacent portion of the outer wall segment.

The lip may project at least a height of 0.400 inch beyond adjacent portion of the outer wall segment. The lip may have a thickness of 0.06-0.09 inch. The outer wall segment outboard surface may have a recess at least immediately ahead of the lip. The lip may circumscribe the bleed port. The lip may be shorter along a trailing edge than along the forward (leading) edge. Along a majority of the lip inner surface extending from the bleed port forward edge, the lip inner surface may have an angle between 40° and 50° relative to the axis. The outer wall segment may include a number of bleed ports. Each bleed port may have a circumferential length of between 2.0 and 2.3 inch. The bleed port may be elongate in the circumferential direction about the axis. The segment may further include a second inner wall segment having inboard and outboard surfaces and a second plurality of airfoils forming a sector of a second airfoil stage and extending between the second inner wall segment and the outer wall segment. The first airfoil segment may be ahead of the bleed ports and the second behind. The segment may be formed essentially as a unitary casting of a nickel-based superalloy.

Another aspect of the invention involves a turbine engine compressor. The compressor has a case having an axis, a number of rings of vanes, and a number of rings of blades alternating with the vane rings and coaxial therewith about the axis and mounted for rotation about the axis. The case has a core outboard wall having an inboard surface essentially locally bounding an outboard extreme of a core flowpath sequentially through the alternating rings of vanes and blades. At least one additional wall cooperates with the core outboard wall to bound a bleed air plenum outboard of the core flowpath. A number of bleed ports in the core outboard wall provide communication from the core flowpath to the bleed air plenum. A number of bleed port leading walls extend from the core outboard wall at a leading edge of associated bleed ports into the bleed air plenum and have port length to depth ratios of 2.5:1-3.5:1. The ratios may be 2.8-3.2. The case may be an assembly including a number of segments assembled longitudinally and circumferentially. The vanes may be unitarily formed with associated ones of the segments.

Another aspect of the invention involves a method for modifying a turbine engine compressor. A first outer wall segment is removed and replaced with a replacement having bleed ports bounded along a forward edge by a lip projecting rearward and radially outward. The lip has inner and outer surfaces and a rim and projects at least a height radially beyond an adjacent portion of the outer wall of the second segment.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a partial longitudinal sectional view of a turbine engine high compressor.

FIG. 1A is an enlarged view of a bleed port of the compressor of FIG. 1.

FIG. 2 is a longitudinal sectional view of an alternate bleed port.

FIG. 3 is a longitudinal sectional view of a second alternate bleed port.

FIG. 4 is a view of a prior art engine stator segment.

FIG. 5 is a view of a stator segment of the compressor of FIG. 1.

Like reference numbers and designations in the various drawings indicate like elements.

### DETAILED DESCRIPTION

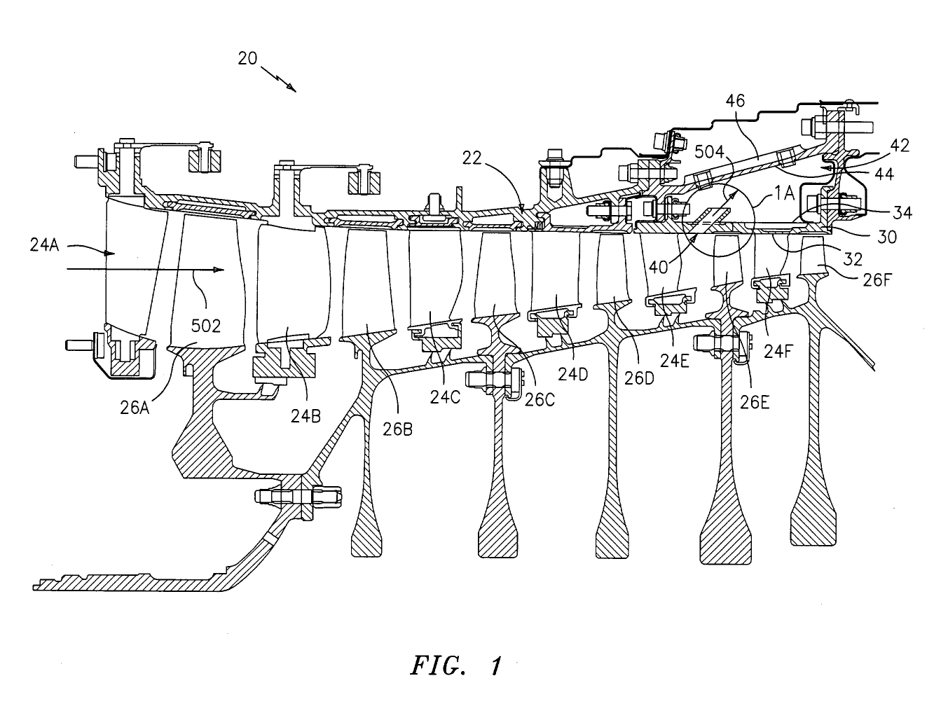

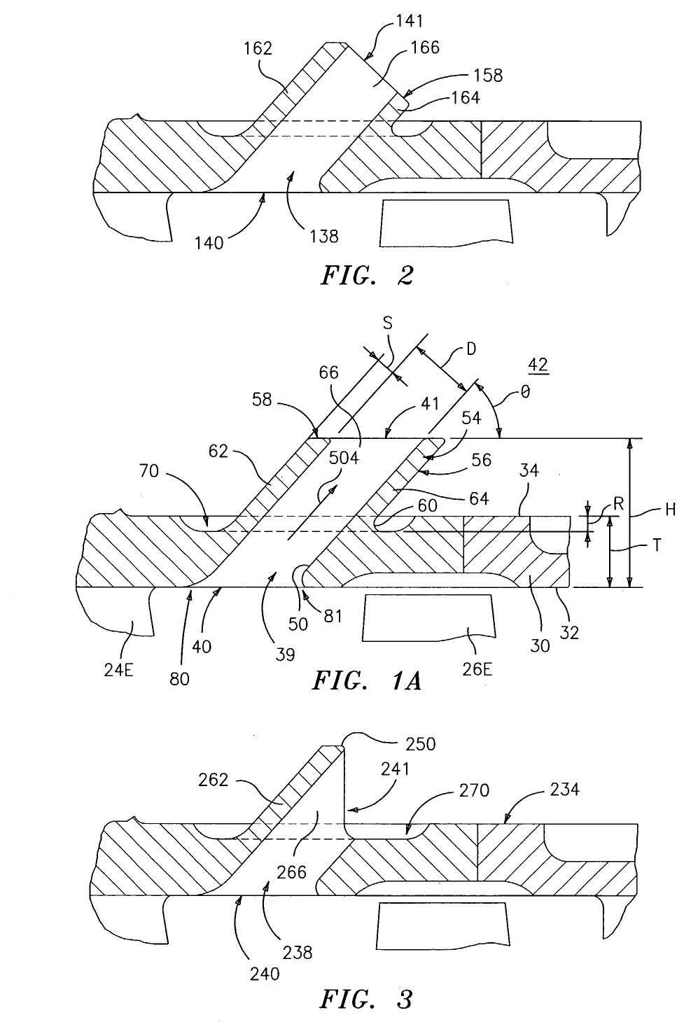

FIG. 1 shows a turbine engine high pressure/speed compressor 20. The compressor has a case assembly 22 circumscribing a central longitudinal axis or centerline 500 (spacing not to scale). The exemplary compressor includes alternating rings of vanes 24A-24F and blades 26A-26F. The exemplary case 22 has a wall 30 having inboard and outboard surfaces 32 and 34. The inboard surface defines an outboard boundary/wall of a core flowpath 502. An inboard boundary/wall of the flowpath 502 is largely defined by platforms of the vanes and blades.

The exemplary wall 30 is provided with a plurality of bleed ports 38 having inlets 40 and outlets 41 diverting a bleed flow 504 from the core flowpath 502 to a bleed manifold or plenum 42 circumscribing the wall 30 and inboard bounded by the surface 34 and outboard bounded by an interior surface 44 of a case second wall 46. In the exemplary implementation, the ports 40 are circumferentially arrayed along the wall 30. In the exemplary implementation, the bleed ports 38 fall between two vane stages 24E and 24F and, more particularly, between a vane stage 24E and the following blade stage 26E. In an exemplary implementation, the vane stage 24E is the seventh stage (there being two additional stages in the low compressor and the inlet guide vane ring 24A not typically being counted as a separate stage).

FIG. 1A shows further details of the bleed port 38. The port has an interior surface 50 which converges slightly from upstream to downstream near its upstream end at the surface 32. The surface 50 extends radially outward therefrom as a generally right slot at a longitudinal angle θ to the axis 500. The local wall inboard surface 32 may be somewhat off-longitudinal (e.g., converging slightly such as by up to about 1°) at this point. The surface 50 extends along a lip formed as tubular projection 54 radially outward and aft into the plenum 42 beyond a generally cylindrical local portion of the surface 34. This projection or lip has an exterior/outer surface 56 and a downstream rim surface 58. The exterior surface 56 is generally parallel to the interior surface 50 outboard of a root transition 60 along the lip's leading and trailing edge portions 62 and 64 and lateral portions 66. In the exemplary embodiment, the transition 60 is sub-flush to the local cylindrical portion of the surface 34 defining a recess 70 circumscribing the lip 54. The exemplary bleed port has a length L along the bleed flowpath 504. In the exemplary embodiment, the leading and trailing edges of the bleed port inlet 80 and 81 are longitudinally radiused. The length may thus advantageously be measured from the projected intersection of the straight medial portions of the interior surface 50 along the leading edge wall or portion 62. The interior of the rim surface 50 may be much more sharply radiused and the length may be measured to a similarly projected value (the projection difference creating a relatively insignificant difference). The length may alternatively be measured near the trailing edge of the port or in-between. As discussed below, performance is believed more sensitive to length along the leading edge and, therefore, this measurement location is contemplated unless otherwise noted. The exemplary bleed port is elongate in the circumferential direction about the axis 500. Its smaller dimension is thus transverse to the flowpath 504 and has a depth D. The port height (e.g., of the rim 58 radially beyond the surface 32) is Lsinθ. Additional dimensions shown are the thickness T of the unrecessed portions of the wall 30 (e.g., between the cylindrical portions of the surfaces 32 and 34), the depth R of the recess 70 (e.g., of the nadir of the recess below the cylindrical portion of the surface 34), and the thickness S of the lip 54 away from its root and tip.

In an exemplary embodiment, the ratio of L to D is chosen to be approximately 3.0 (e.g., 2.5-3.5 or, more narrowly, 2.8-3.2). Exemplary values of L and D are 0.88 and 0.29 inches. A broader range of L is 0.7-1.0 inch. An exemplary value of θ is 45.87°. An exemplary range of θ is 40°-50°. Narrower ranges are 43°-47° and 44°-46°. An exemplary lip wall thickness S is 0.080 inch. An exemplary range is 0.060-0.090 inch. A narrower range is 0.065-0.085 inch. An exemplary height H is 0.674 inch. An exemplary range is 0.60-0.75 inch. A narrower range is 0.65-0.70 inch. An exemplary case wall thickness T is 0.245 inch. An exemplary difference between H and T is at least 0.4 inch. A narrower difference range is at least 0.5 inch. An exemplary recess depth R is 0.06 inch. An exemplary range is 0.05-0.07 inch. An exemplary longitudinal radius of curvature at the leading edge of the inlet of the bleed port is 0.12 inch. An exemplary range is 0.09-0.25 inch. An exemplary radius of curvature at the downstream edge of the inlet port is 0.031 inch. An exemplary range is 0.024-0.063 inch. The depth and geometry of the recess are selected for weight reduction in view of strength considerations. To maintain strength, a transition 60 is curved, having a relatively tight radius of curvature along the trailing wall 64 and a greater radius of curvature along the leading wall 62. The relative straightness of the port (especially of the downstream portion of the port near its rim) and the size/shape of the recess are artifacts of weight and manufacturability concerns. Ideally, to minimize flow disturbance and increase diffusion (and thereby minimize pressure losses through the bleed port) the port would diverge near its downstream end. Computationally, it appears that ratios of L to D approaching or exceeding 3:1 exhibit a high reduction in flow separation. Ratios substantially greater than 3:1 appear to provide little additional flow benefit to justify the weight penalty.

A further reduction in weight may be obtained by further truncating the portion of the lip along the trailing edge or extreme of the bleed port so that the outlet is more nearly perpendicular to the bleed flow 504. It appears that flow performance is not particularly sensitive to this shortening. FIG. 2 shows a bleed port 138 having an inlet 140 similarly dimensioned and positioned to the inlet of the embodiment of FIG. 1A. The outlet 141 defined by the rim 158 is perpendicular to the bleed flow. In the exemplary embodiment, the leading portion 162 of the lip is the same as that of FIG. 1A whereas the trailing portion 164 is relatively shortened and the lateral portions 166 more perpendicular (right) at their downstream ends.

The lower sensitivity to shortening of the trailing portion of the lip appears to be not merely the case when it protrudes farther downstream than does the leading portion. Accordingly, FIG. 3 shows yet another port 238 where the lip trailing portion has been entirely removed so that the trailing portion of the port terminates at the recess 270 in the surface 234. In this exemplary embodiment, the leading portion 262 is substantially the same as the leading portions of FIGS. 1A and 2, as is the inlet 240. The outlet 241 is defined by the rim 258 along the leading portion 262, side portions 266, and along the recess 270 at the trailing edge of the port.

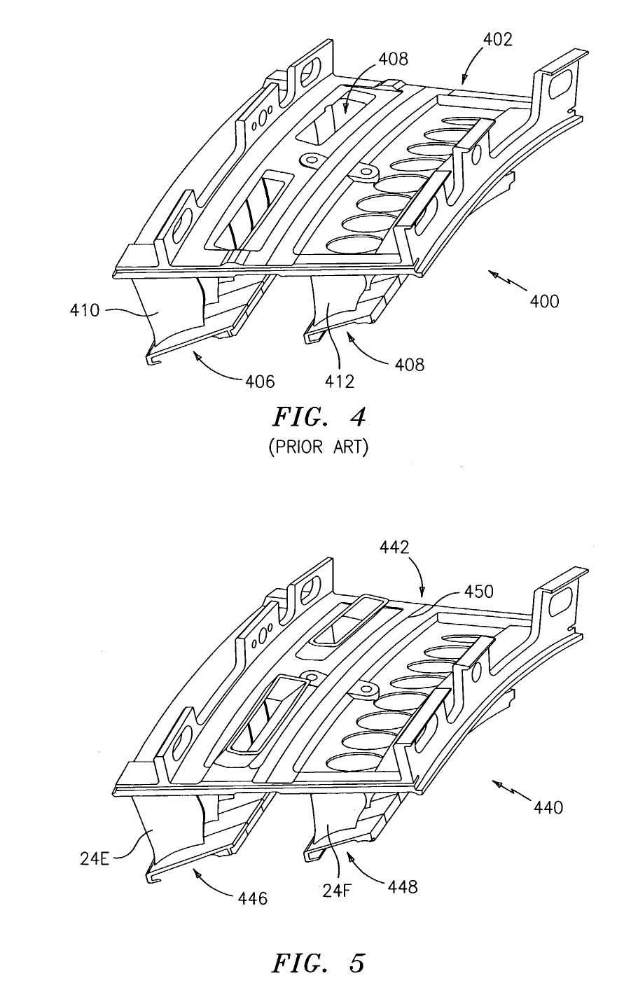

FIG. 4 shows an exemplary prior art engine case segment 400 having an outboard wall segment 402 with inboard and outboard surfaces and a pair of compressor bleed ports 404 therebetween. The exemplary segment 400 has a pair of inboard wall segments 406 and 408 with groups of respective airfoils 410 and 412 extending between the such inboard wall segments and the outboard wall segment 402. In the exemplary embodiment, the segment is dimensioned to nominally encompass 30° about the engine so that twelve such segments may be assembled side-to-side in a ring to provide twenty-four ports and encompass two stator stages of the engine. In an exemplary implementation, exemplary circumferential lengths (lengths along the circumference of the segment about the axis 500 at the port inlet of the ports are 2.0-2.3 inch. More narrowly, 2.1-2.2 inch. Multiple rings may be assembled end-to-end for the additional stages.

The segment 400 of FIG. 4 may be removed from its engine and replaced with a replacement stator segment 440 (FIG. 5). An outboard wall 442 of the segment 440 provides a sector of the case wall 30 of FIG. 1. Inboard wall segments 446 and 448 are respectively connected to the outboard wall segment 442 by groups of the vanes 24E and 24F. The exemplary segment 400 may be formed such as by investment casting of nickel-based superalloy. The exemplary segment can be formed from two unitarily-cast subsegments joined along a circumferential weld 450 such as by electron beam welding. The exemplary weld is aft of the bleed ports dividing the outboard wall segment longitudinally approximately in half with the vanes 24E and inboard wall segment 446 unitarily formed with the leading half and the vanes 24F and inboard wall segment 448 unitarily formed with the trailing half.

One or more embodiments of the present invention have been described. Nevertheless, it will be understood that various modifications may be made without departing from the spirit and scope of the invention. For example, when implemented as a reengineering or retrofit of an existing compressor, details of the existing compressor may influence or dictate details of the implementation. Accordingly, other embodiments are within the scope of the following claims.

What is claimed is:

1. A turbine engine stator segment comprising the combination of:
an outer wall segment having inboard and outboard surfaces;
a first inner wall segment having inboard and outboard surfaces essentially sharing an axis with the inboard and outboard surfaces of the outer wall segment;
a first plurality of airfoils for forming a sector of a first airfoil stage and extending between the first inner wall segment and the outer wall segment,
wherein the outboard wall segment has a compressor bleed port, the bleed port bounded along a forward edge by a lip projecting rearward and radially outward, the lip having inner and outer surfaces and a rim and projecting at least a height of 0.400 inch radially beyond an adjacent portion of the outer wall segment.

2. The segment of claim 1 wherein:
the lip has a thickness of 0.06-0.09 inch along a major portion of the outer surface.

3. The segment of claim 1 wherein:
the outer wall segment outboard surface has a recess immediately ahead of the lip.

4. The segment of claim 1 wherein:
the lip circumscribes the bleed port.

5. The segment of claim 4 wherein:
the lip is shorter along a trailing edge than along said forward edge.

6. The segment of claim 1 wherein:
along a majority of the lip inner surface extending from said bleed port forward edge, the lip inner surface has an angle between 40° and 50° relative to the axis.

7. The segment of claim 4 wherein:
said angle is between 44° and 46°.

8. The segment of claim 1 wherein:
the outer wall segment includes a plurality of bleed ports.

9. The segment of claim 1 wherein:
the bleed port has a circumferential length of at between 2.0 and 2.3 inch.

10. The segment of claim 1 wherein:
the bleed port is elongate in the circumferential direction about the axis.

11. The segment of claim 1 further comprising:
a second inner wall segment having inboard and outboard surfaces; and
a second plurality of airfoils for forming a sector of a second airfoil stage and extending between the second inner wall segment and the outer wall segment, the first airfoil stage being ahead of the plurality of compressor bleed ports and the second airfoil stage being behind of the plurality of compressor bleed ports.

12. The segment of claim 1 formed essentially as a unitary casting of a-nickel-based superalloy.

13. A turbine engine compressor comprising:
a case having an axis;
a plurality of rings of vanes; and
a plurality of rings of blades alternating with the rings of vanes, coaxial therewith about the axis and mounted for rotation about the axis,
wherein the case has:
a core outboard wall having an inboard surface essentially locally bounding an outboard extreme of a core flowpath sequentially through the alternating rings of vanes and blades;
at least one additional wall, cooperating with the core outboard wall to bound a bleed air plenum outboard of the core flowpath;
a plurality of bleed ports in the core outboard wall providing communication from the core flowpath to the bleed air plenum; and
a plurality of bleed port leading walls, extending from the core outboard wall at a leading edge of associated said bleed ports into the bleed air plenum and having port length-to-depth ratios of 2.5:1-3.5:1.

14. The compressor of claim 13 wherein:
said ratios are 2.8-3.2.

15. The compressor of claim 13 wherein:
said case comprises an assembly including a plurality of segments assembled longitudinally and circumferentially; and
said vanes of said plurality of rings of vanes are unitarily formed with associated ones of said segments.

16. A method for modifying a turbine engine compressor comprising:
removing a first outer wall segment having inboard and outboard surfaces and a compressor bleed port, the bleed port being bounded along front and rear edges by generally longitudinally-extending portions of the outer wall segment; and
replacing the first outer wall segment with a second outer wall segment having inboard and outboard surfaces and a compressor bleed port, the bleed port bounded along a forward edge by a lip projecting rearward and radially outward, the lip having inner and outer surfaces and a rim and projecting at least a height radially beyond an adjacent portion of the second outer wall segment.

17. The method of claim 16 wherein:
the removing comprises removing a first engine stator segment comprising:
the first outer wall;
a first inner wall segment having inboard and outboard surfaces essentially sharing an axis with the inboard and outboard surfaces of the first outer wall segment; and
a first plurality of airfoils for forming a sector of an airfoil stage and extending between the first inner wall segment and the first outer wall segment; and
the replacing comprises replacing the first engine stator segment with a second engine stator segment comprising:
the second outer wall segment;
a second inner wall segment having inboard and outboard surfaces essentially sharing an axis with the inboard and outboard surfaces of the second outer wall segment; and
a second plurality of airfoils for forming a sector of a an airfoil stage and extending between the second inner wall segment and the second outer wall segment.

18. The method of claim 16 wherein:
the first engine stator segment is removed as a unit; and
the second engine stator segment is installed as a unit.
